(19) United States
(12) Patent Application Publication
(10) Pub. No.: US 2019/0131734 A1
(43) Pub. Date: May 2, 2019

(54) CONTACT ASSEMBLY AND METHOD FOR FORMING A CONTACT ASSEMBLY

(71) Applicant: SCHUNK CARBON TECHNOLOGY GMBH, Bad Goisem (AT)

(72) Inventor: Georg Höll, Bad Goisern (AT)

(21) Appl. No.: 16/099,874

(22) PCT Filed: Feb. 1, 2017
(86) PCT No.: PCT/EP2017/052139

§ 371 Date: Nov. 8, 2018

(30) Foreign Application Priority Data
May 13, 2016 (DE) 10 2016 208 326.0

(51) Int. Cl. H01R 13/03; H01R 4/02

(52) U.S. Cl. CPC H01R 13/03; H01R 4/029

(57) ABSTRACT

Contact assembly comprising a contact pin and an electrical connecting conductor, wherein the contact pin has a flat pin contact surface extending in the direction of the pin longitudinal axis, and the connecting conductor has a conductor contact surface extending in the direction of the conductor longitudinal axis transverse to the pin longitudinal axis, wherein at an intersection point of the pin longitudinal axis and the conductor longitudinal axis, the ratio of a contact pin width to a conductor width is designed to be greater than 2:1, and the contact pin is welded to the conductor in an overlapping region of the pin contact surface and the conductor contact surface, wherein at the intersection point of the pin longitudinal axis and the conductor longitudinal axis, the ratio of a pin contact surface width to a conductor contact surface width is designed to be smaller than 2:1.

The invention relates to a contact assembly and to a method for forming a contact assembly, comprising a contact pin and an electrical connecting conductor, wherein the contact pin has a flat pin contact surface which extends in the direction of the pin longitudinal axis, and the connecting conductor has a conductor contact surface which extends in the direction of the conductor longitudinal axis, said pin longitudinal axis being arranged transversely to the conductor longitudinal axis, wherein the contact pin has a contact pin width (B) and the connecting conductor has a connecting conductor width (b), wherein at an intersection point of the pin longitudinal axis and the conductor longitudinal axis, the ratio of the contact pin width to the terminal conductor width is designed to be greater than 2:1, and the contact pin is welded to the terminal conductor in an overlapping region of the pin contact surface and the conductor contact surface, wherein the pin contact surface has a pin contact surface width (B′), and the conductor contact surface has a conductor contact surface width (b′).

In the case of such contact assemblies, it is known to connect the contact pin, which can, for example, be round, to a connecting conductor arranged transversely to the contact pin. The connection takes place by means of welding the contact pin to the connecting conductor, wherein the connecting conductor are at least softened or melted at least in an overlapping region of the connecting conductor and the contact pin, as well as a surface of the contact pin within this overlapping region so that a substance-to-substance welding connection between the connecting conductor and the contact pin is formed. In itself, the contact pin can be used for various contacting purposes, for example, as a plug or as part of a plug of an electrical connection.

In particular, contact assemblies are known where a flat pin contact surface is formed on the contact pin, which should facilitate a pressing and welding of the connecting conductor. Since a diameter of the connecting conductor is regularly many times smaller than a diameter of the contact pin, it is viewed as being favourable, with the pin contact surface, to provide the largest possible overlapping region of the connecting conductor and the conductor contact surface and the pin contact surface to accordingly establish a large-area welding contact. A large overlapping region and, thereby, a large-area welding contact makes transmitting higher currents possible and ensures a stable connection of the contact pin and the connecting conductor. However, as has been shown in practical applications, durability of such a weld contact does not always exist. Depending on the intended purpose of the contact assembly, after a period of time of use, it can result in the connecting conductor adjacent to the welding contact or the overlapping region breaking.

It is therefore the object of the invention to propose a contact assembly and a method to produce a contact assembly, by means of which an improved durability of the contact assembly can be achieved.

This task is achieved by means of a contact assembly with the features of claim 1 and a method with the features of claim 11.

The contact assembly according to the invention comprises a contact pin and an electrical connecting conductor, wherein the contact pin has a flat pin contact surface which extends in the direction of the pin longitudinal axis, and the connecting conductor has a conductor contact surface, which extends in the direction of the conductor longitudinal axis, said pin longitudinal axis being arranged transversely to the conductor longitudinal axis, wherein the contact pin has a contact pin width (B) and the connecting conductor has a connecting conductor width (b), wherein at an intersection point of the pin longitudinal axis and the conductor longitudinal axis, the ratio of the contact pin width to the terminal conductor width is designed to be greater than 2:1, and the contact pin is welded to the terminal conductor in an overlapping region of the pin contact surface and the conductor contact surface, wherein the pin contact surface has a pin contact surface width (B′), and the conductor contact surface has a conductor contact surface width (b′), wherein at the intersection point of the pin longitudinal axis and the conductor longitudinal axis, the ratio of the pin contact surface width to the conductor contact surface width is designed to be smaller than 2:1.

In accordance with this, the contact pin comprises a multiply larger diameter or cross-section than the connecting conductor, wherein, according to the invention, it is provided to design the pin contact surface width at a smaller ratio so that the conductor contact surface width is not yet even twice as big as a diameter of the connecting conductor. In this way, it can be prevented that the connecting conductor is welded to the contact pin across a longer section. Surprisingly, it has been shown that it less frequently results in the connecting conductor adjacent to the overlapping region breaking if the ratio of the pin contact surface width to the conductor contact surface width is designed to be smaller than 2:1. By means of this, a cross-section of such a formed welding contact is made smaller and therefore supposedly more instable, however, the contact pin and the connecting conductor in the overlapping region are more evenly softened and melted. In the case of contact assembly known from the most recent prior art, the comparably thin connecting conductor in the overlapping region melts considerably faster due to its comparably low mass than the relatively thick contact pin since this does not heat up as quickly as the connecting conductor. A stable welding contact can be formed in such a way, however, due to the advanced melding of the contacting conductor adjacent to the overlapping region, breakage on the connecting conductor often results. If, due to the ratio between the pin contact surface width to the conductor contact surface width, a size of the overlapping region is limited, the connecting conductor and the contact pin can melt more evenly in the overlapping region since less heat is dissipated into the contact pin during welding or can only be dissipated slowly due to the smaller surface contact of the contact pin. In this way, a welding connection can be formed where the connecting conductor is melted less intensely, which reduces the risk of breakage adjacent to the overlapping region.

In a preferred embodiment, the contact pin can be made of brass and the connecting conductor can be made of copper. However, principally, it is also possible to manufacture the contact pin and the connecting conductor from other metals that can be welded to each other well. It can also be provided that the contact pin and/or the connecting conductor comprise a coating, for example, a coating with a galvanically applied conductive material or one that is applied by means of a dipping method.

The connecting conductor can also be a wire strand or a cable made of wire strands. A risk of breaking the connecting conductor is reduced again due to this and the contact assembly can also be used for applications where the connecting conductor is subjected to vibrations or a movement.

The pin contact surface width can be designed to be at a ratio to the conductor contact surface width of smaller than 1.5:1, preferably 1:1, particularly preferred greater than 0.5:1. In the case of such a reduced ratio, a risk of breakage of the connecting conductor is reduced even further and results in a more even substance-to-substance connection between the connecting conductor and the contact pin.

The overlapping region can be rectangular, cuboid or rhombus-shaped. If the overlapping region is cuboid, the ratio between the pin contact surface width to the conductor contact surface width is 1:1. If the conductor longitudinal axis does not run at an angle of 90° to the pin longitudinal axis, but deviates from this, a rhombus-shaped formation of the overlapping region results.

The ratio between the pin contact surface width to the conductor contact surface width can have a tolerance or a deviation of less than 10%. As a consequence, welding can also be automated, thereby taking place within a tolerance range of 10%.

On both sides of the pin contact surface, boundary surfaces relatively inclined toward this are formed. The boundaries surfaces then determined a size of the pin contact surface or the pin contact surface width (B′) and ensure, by means of the inclination, that the connecting conductor alone is not welded to the pin contact surface and not to the boundary surfaces.

A cross-section of the connecting conductor can be round and can comprise parallel outer surfaces in the overlapping region. In particular, if the connecting conductor is pressed onto the pin contact surface by means of the stamp for welding, the connecting conductor cannot be shaped so easily that the outer surfaces are essentially arranged in parallel.

A cross-section of the contact pin can also be round. However, in principle, it is also possible that the contact pin or its cross-section can comprise any thinkable shape, wherein, then, however, the pin contact surface is always flat. The pin contact surface can, for example be formed on the contact pin by partially machining, such as milling or grinding.

The fuel pump according to the invention comprises a contact assembly according to the invention according to one of the preceding claims. In accordance with this, the contact assembly is used for a fuel pump, a petrol pump, diesel pump or the like. Since such fuel pumps are regularly replaced and not repaired, a failure of the fuel pump due to breakage of the connecting conductor can be prevented with the contact assembly. Other favourable embodiments of a fuel pump result from the sub claims referring back to the apparatus claim 1.

In the case of the method to form a contact assembly, a flat contact pin surface is formed on a contact pin, which extends in a direction of a pin longitudinal axis, wherein a conductor contact surface is formed on an electrical connecting conductor, which extends in the direction of a conductor longitudinal axis, wherein the pin longitudinal axis is arranged transversely to the conductor longitudinal axis, wherein a ratio between contact pin width (B) of the contact pin to a contact conductor width (b) of the connecting conductor is designed to be 2:1, wherein the contact pin is welded to the connecting conductor in an overlapping region of the pin contact surface and the conductor contact surface, wherein the ratio between the pin contact surface width (B′) of the pin contact surface to a conductor contact surface width (b′) of the conductor contact surface is designed to be smaller than 2:1. Concerning the benefits of the method according to the invention, reference will be made to the benefit description of the contact assembly according to the invention.

In the following, an embodiment of the invention will be explained in more detail taking the enclosed drawings into consideration.

The figures show:

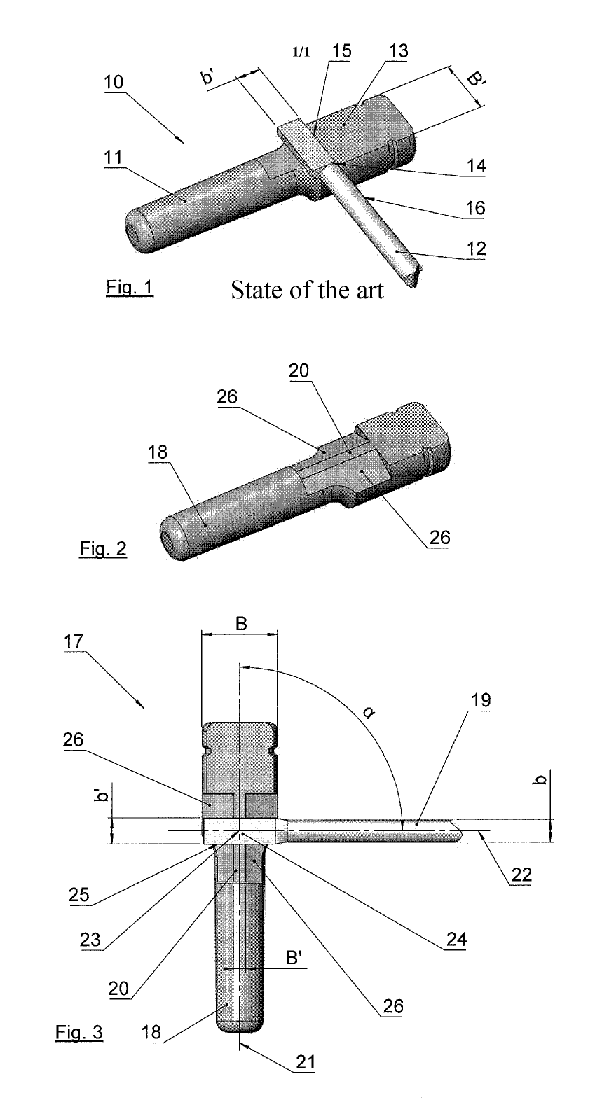

FIG. 1 a contact assembly according to the most recent prior art;

FIG. 2 a contact pin in a perspective view;

FIG. 3 a contact assembly in a top view.

FIG. 1 shows a contact assembly 10 according to the most recent prior art with a contact pin 11 and a connecting conductor 12. A pin contact surface 13 is formed on the contact pin 11, on which the connecting conductor 12 has been applied and pressed against the pin contact surface 13 by means of a stamp (not shown here) and has been welded to this. In the case of the contact assembly 10, it is essential that the ratio of a pin contact surface width (B′) to a conductor contact surface width (b′) is designed to be greater than 2:1. In the case of using the contact assembly 10, breakage of the connecting conductor 12 often occurs in an overlapping region 14 between a conductor contact area and a conductor section 16.

An overall view of FIGS. 2 and 3 shows a contact assembly 17 with a contact pin 18 and a connecting conductor 19, wherein the contact pin 18 and the connecting conductor 19 are each essentially formed with a round cross-section. A flat pin contact surface 20 is formed on the contact pin 18, which extends in the direction of a pin longitudinal axis 21. Along the same lines, a conductor contact surface 25 is formed on the connecting conductor 19, which extends in the direction of a conductor longitudinal axis 22. The pin longitudinal axis 21 is arranged transversely at an angle a of 90° relative to the conductor longitudinal axis 22 so that an intersection point 23 of the pin longitudinal axis and the conductor longitudinal axis 22 results. Furthermore, a contact pin width (B) of the contact pin 18 at a ratio to a connecting conductor width (b) of the connecting conductor 19 is considerably larger, in particular, larger than 2:1. The pin contact surface 20 is covered in an overlapping region 24 of a conductor contact surface 25 of the connecting conductor 19 and is connected in a substance-to-substance manner to the conductor contact surface 25 in the overlapping region 24 by means of welding. Furthermore, boundary surfaces 26 are formed on the contact pin 18, which limit the pin contact surface 20 with regard to its pin contact surface width (B′). In this way, it is possible for the ratio between the pin contact surface width (B′) relative to a conductor contact surface width (b′) to be smaller than 2:1. Thereby, the conductor contact surface width (b′) essentially corresponds to the connecting conductor width (b).

1. Contact assembly (17), comprising a contact pin (18) and an electrical connecting conductor (19), wherein the contact pin has a flat pin contact surface (20) which extends in the direction of the pin longitudinal axis (21), and the connecting conductor has a conductor contact surface (25) which extends in the direction of the conductor longitudinal axis (22), said pin longitudinal axis being arranged transversely to the conductor longitudinal axis, wherein the contact pin has a contact pin width (B) and the connecting conductor has a connecting conductor width (b), wherein at an intersection point (23) of the pin longitudinal axis and the conductor longitudinal axis, the ratio of the contact pin width to the terminal conductor width is designed to be greater than 2:1, and the contact pin is welded to the terminal conductor in an overlapping region (24) of the pin contact surface and the conductor contact surface, wherein the pin contact surface has a pin contact surface width (B′), and the conductor contact surface has a conductor contact surface width (b′), characterized in that, at the intersection point of the pin longitudinal axis and the conductor longitudinal axis, the ratio of the pin contact surface width to the conductor contact surface width is designed to be smaller than 2:1.

2. Contact assembly according to claim 1, characterized in that the contact pin (18) is made of brass and the connecting conductor (19) is made of copper.

3. Contact assembly according to claim 1, characterized in that the connecting conductor (19) is a wire strand.

4. Contact assembly according to claim 1, characterized in that the ratio of the pin contact surface width (B′) to the conductor contact surface width (b′) is designed to be smaller than 1.5:1, preferably 1:1, particularly preferred greater than 0.5:1.

5. Contact assembly according to claim 1, characterized in that the overlapping region (24) is rectangular, cuboid or rhombus-shaped.

6. Contact assembly according to claim 1, characterized in that the ratio of the pin contact surface width (B′) to the conductor contact surface width (b′) is designed to have a tolerance of less than 10%.

7. Contact assembly according to claim 1, characterized in that on both sides of the pin contact surface (20), boundary surfaces (26) relatively inclined toward this are formed.

8. Contact assembly according to claim 1, characterized in that a cross-section of the connecting conductor (19) is round and has parallel outer surfaces in the overlapping region (24).

9. Contact assembly according to claim 1, characterized in that a cross-section of the contact pin (18) is round.

10. Fuel pump with a contact assembly (17) according to claim 1.

11. Method to form a contact assembly (17), wherein a flat pin contact surface (20) is formed on a contact pin (18), which extends in the direction of a pin longitudinal axis (21), wherein a conductor contact surface (25) is formed on an electrical connecting conductor (19), which extends in the direction of a conductor longitudinal axis (22), wherein the pin longitudinal axis is arranged transversely to the conductor longitudinal axis, wherein, at an intersection point (23) of the pin longitudinal axis and the conductor longitudinal axis, a ratio between a contact pin width (B) of the contact pin to a connecting conductor width (b) of the connecting conductor is designed to be larger than 2:1, wherein the contact pin is welded to the connecting conductor in an overlapping region (24) of the pin contact surface and the conductor contact surface, characterized in that at the intersection point of the pin longitudinal axis and the conductor longitudinal axis, the ratio of a pin contact surface width (B′) to a conductor contact surface width (b′) of the conductor contact surface is designed to be smaller than 2:1.
